(19) United States
(12) Patent Application Publication
(10) Pub. No.: US 2011/0197268 A1
(43) Pub. Date: Aug. 11, 2011

(54) CAPTCHAS THAT INCLUDE OVERLAPPED CHARACTERS, PROJECTIONS ON VIRTUAL 3D SURFACES, AND/OR VIRTUAL 3D OBJECTS

(75) Inventors: Shanmugasundaram Ravikumar, Santa Clara, CA (US); Anirban Dasgupta, Berkeley, CA (US); Kunal Punera, Mountain View, CA (US); Achint Oommen Thomas, Tonawanda, NY (US)

(73) Assignee: YAHOO! INC., Sunnyvale, CA (US)

(21) Appl. No.: 12/701,347

(22) Filed: Feb. 5, 2010

(51) Int. Cl. H04L 9/32

(52) U.S. Cl. 726/6; 345/419; 345/426; 345/629

(57) ABSTRACT

Techniques are described herein for generating CAPTCHAs that include overlapped characters, projections on virtual three-dimensional (3D) surfaces, and/or virtual 3D objects. A CAPTCHA is a type of challenge-response test that a content provider may present to users for authorizing the users to access content that the content provider hosts. For example, when a user attempts to access content, a CAPTCHA may be generated in accordance with one or more of the techniques described herein and provided to the user. The user may be asked to identify characters that overlap in the CAPTCHA, characters that are projected on a virtual 3D surface, and/or a designated virtual 3D object, so that the user may be authorized to access the content. The user may enter the characters and/or select the designated virtual 3D object that is identified in the CAPTCHA using an input device, such as a keyboard, touch screen, pointing device, etc.

### BACKGROUND OF THE INVENTION

1. Field of the Invention

The present invention relates to techniques for generating CAPTCHAs.

2. Background

A CAPTCHA is a type of challenge-response test that a content provider may present to users of a networked computer system for authorizing the users to access content that is hosted by the content provider. A content provider may be a webmail provider, a blog, a forum, a wiki, etc. For instance, a provider of a Web site may present a CAPTCHA to users who attempt to access the Web site, so that the provider may determine whether the users are humans or automated systems (a.k.a. bots). Automated systems often execute attacks that attempt to bypass the CAPTCHAs that are provided by content providers. If the automated systems are able to bypass the CAPTCHAs, the automated systems typically abuse the privileges that are offered by the content providers by sending SPAM emails, providing offensive posts, etc. and/or by consuming substantial resources of the content providers. Accordingly, such attacks often degrade the quality of service of the content providers, which may result in monetary and/or reputational losses for the providers.

Efforts have been made to develop CAPTCHAs that are capable of resisting attacks that are initiated by automated systems but that are solvable by humans without undue difficulty. The more resilient a CAPTCHA is to such attacks while remaining reasonably solvable by humans, the more effective the CAPTCHA is said to be. CAPTCHAs typically include a string of characters (e.g., letters and/or numbers) that a user is asked to transcribe. Traditional techniques for generating CAPTCHAs often add noise to the characters and/or to an area that surrounds the characters and maintain a relatively close spacing between the characters to increase the effectiveness of the CAPTCHAs.

However, automated systems are becoming increasingly sophisticated, such that the success rate of the automated systems for solving CAPTCHAs that are generated using traditional techniques may be substantially the same as the success rate of humans for solving the CAPTCHAs. For instance, automated systems may attempt to solve a CAPTCHA by segmenting a string of characters that is included in the CAPTCHA into individual characters. Each character then may be identified using a technique such as optical character recognition (OCR).

Thus, systems, methods, and computer program products are needed that address one or more of the aforementioned shortcomings of conventional techniques for generating CAPTCHAs.

### BRIEF SUMMARY OF THE INVENTION

Various approaches are described herein for, among other things, generating CAPTCHAs that include overlapped characters, projections on virtual three-dimensional (3D) surfaces, and/or virtual 3D objects. A CAPTCHA is a type of challenge-response test that a content provider may present to users of a networked computer system for authorizing the users to access content that is hosted by the content provider. For example, when a user attempts to access content, a CAPTCHA may be generated in accordance with any one or more of the approaches described herein. The CAPTCHA may be provided to the user, and the user may be asked to identify characters that overlap in the CAPTCHA, characters that are projected on a virtual 3D surface, and/or a designated virtual 3D object, so that the user may be authorized to access the content. The user may enter the characters and/or select the designated virtual 3D object that is identified in the CAPTCHA using an input device, such as a keyboard, touch screen, pointing device, etc.

An example method is described for generating a CAPTCHA that includes overlapped characters. In accordance with this example method, a first character is generated that has a first outer boundary. A second character is generated that has a second outer boundary. The second outer boundary intersects the first outer boundary to provide an overlapping region with respect to the first and second characters. A determination is made that the overlapping region is to be attributable to a specified character. The specified character is the first character or the second character. A CAPTCHA is provided to a user. The CAPTCHA includes the first character and the second character arranged such that the overlapping region is attributable to the specified character.

An example method is described for generating a CAPTCHA that includes a projection on a virtual 3D surface. In accordance with this example method, a string of characters is generated. A virtual 3D surface is generated. The string of characters is projected on the virtual 3D surface to provide a 3D scene. The 3D scene includes the virtual 3D surface having a projection of the string of characters thereon. A CAPTCHA that includes the 3D scene is provided to a user.

An example method is described for generating a CAPTCHA that includes virtual 3D objects. In accordance with this example method, virtual 3D objects are randomly selected. The virtual 3D objects are randomly combined to generate a virtual 3D structure. A CAPTCHA that includes the virtual 3D structure is provided to a user. A request is made for the user to identify a designated virtual 3D object of the virtual 3D objects in the virtual 3D structure.

Example systems are also described. A first example system includes a character generator, an attribution module, and a CAPTCHA provider. The character generator is configured to generate a first character that has a first outer boundary. The character generator is further configured to generate a second character that has a second outer boundary. The second outer boundary intersects the first outer boundary to provide an overlapping region with respect to the first and second characters. The attribution module is configured to determine that the overlapping region is to be attributable to a specified character. The specified character is the first character or the second character. The CAPTCHA provider is configured to provide a CAPTCHA to a user. The CAPTCHA includes the first character and the second character arranged such that the overlapping region is attributable to the specified character.

A second example system includes a character generator, a surface generator, a projector module, and a CAPTCHA provider. The character generator is configured to generate a string of characters. The surface generator is configured to generate a virtual 3D surface. The projector module is configured to project the string of characters on the virtual 3D surface to provide a 3D scene. The 3D scene includes the virtual 3D surface having a projection of the string of characters thereon. The CAPTCHA provider is configured to provide a CAPTCHA that includes the 3D scene to a user.

A third example system includes an object selector, an object combiner, a

CAPTCHA provider, and a request module. The object selector is configured to randomly select virtual 3D objects. The object combiner is configured to randomly combine the virtual 3D objects to generate a virtual 3D structure. The CAPTCHA provider is configured to provide a CAPTCHA that includes the virtual 3D structure to a user. The request module is configured to request that the user identify a designated virtual 3D object of the virtual 3D objects in the virtual 3D structure.

Example computer program products are also described. A first computer program product includes a computer-readable medium having computer program logic recorded thereon for enabling a processor-based system to generate a CAPTCHA that includes overlapped characters. The computer program logic includes first, second, third, and fourth program logic modules. The first program logic module is for enabling the processor-based system to generate a first character that has a first outer boundary. The second program logic module is for enabling the processor-based system to generate a second character that has a second outer boundary. The second outer boundary intersects the first outer boundary to provide an overlapping region with respect to the first and second characters. The third program logic module is for enabling the processor-based system to determine that the overlapping region is to be attributable to a specified character. The specified character is the first character or the second character. The fourth program logic module is for enabling the processor-based system to provide a CAPTCHA to a user. The CAPTCHA includes the first character and the second character arranged such that the overlapping region is attributable to the specified character.

A second computer program product includes a computer-readable medium having computer program logic recorded thereon for enabling a processor-based system to generate a CAPTCHA that includes a projection on a virtual 3D surface. The computer program logic includes first, second, third, and fourth program logic modules. The first program logic module is for enabling the processor-based system to generate a string of characters. The second program logic module is for enabling the processor-based system to generate a virtual 3D surface. The third program logic module is for enabling the processor-based system to project the string of characters on the virtual 3D surface to provide a 3D scene. The 3D scene includes the virtual 3D surface having a projection of the string of characters thereon. The fourth program logic module is for enabling the processor-based system to provide a CAPTCHA that includes the 3D scene to a user.

A third computer program product includes a computer-readable medium having computer program logic recorded thereon for enabling a processor-based system to generate a CAPTCHA that includes virtual 3D objects. The computer program logic includes first, second, third, and fourth program logic modules. The first program logic module is for enabling the processor-based system to randomly select virtual 3D objects. The second program logic module is for enabling the processor-based system to randomly combine the virtual 3D objects to generate a virtual 3D structure. The third program logic module is for enabling the processor-based system to provide a CAPTCHA that includes the virtual 3D structure to a user. The fourth program logic module is for enabling the processor-based system to request that the user identify a designated virtual 3D object of the virtual 3D objects in the virtual 3D structure.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant arts) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example computer system in accordance with an embodiment described herein.

FIGS. 2-4 depict flowcharts of example methods of generating a CAPTCHA that includes overlapped characters in accordance with embodiments described herein.

FIGS. 5, 11, and 19 are block diagrams of example implementations of a server shown in FIG. 1 in accordance with embodiments described herein.

FIGS. 6-8 show example CAPTCHAs that include overlapped characters in accordance with embodiments described herein.

FIGS. 9A-9B show respective portions of a flowchart of an example method of selectively providing access to content in accordance with an embodiment described herein.

FIG. 10 shows a flowchart of another example method of selectively providing access to content in accordance with an embodiment described herein.

FIG. 12 shows a flowchart of an example method of generating a virtual three-dimensional surface in accordance with an embodiment described herein.

FIG. 13 is a block diagram of an example implementation of a surface generator shown in FIG. 11 in accordance with embodiments described herein.

FIGS. 14-17 show example CAPTCHAs that include projections on virtual 3D surfaces in accordance with embodiments described herein.

FIG. 18 depicts a flowchart of an example method of generating a CAPTCHA that includes virtual 3D objects in accordance with an embodiment described herein.

FIG. 20 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Example embodiments are capable of generating CAPTCHAs that include overlapped characters, projections on virtual three-dimensional (3D) surfaces, and/or virtual 3D objects. A CAPTCHA is a type of challenge-response test that a content provider may present to users of a networked computer system for authorizing the users to access content that is hosted by the content provider. For example, when a user attempts to access content, a CAPTCHA may be generated in accordance with any one or more of the approaches described herein. The CAPTCHA may be provided to the user, and the user may be asked to identify characters that overlap in the CAPTCHA, characters that are projected on a virtual 3D surface, and/or a designated virtual 3D object, so that the user may be authorized to access the content. The user may enter the characters and/or select the designated virtual 3D object that is identified in the CAPTCHA using an input device, such as a keyboard, touch screen, pointing device, etc.

Techniques described herein for generating CAPTCHAs have a variety of benefits as compared to conventional techniques for generating CAPTCHAs. For example, the techniques described herein may generate CAPTCHAs that are more resilient to attacks by automated systems. For instance, the automated systems may be unable to solve the CAPTCHAs using traditional segmentation and character identification techniques. Embodiments in which CAPTCHAs that include overlapped characters are generated may take advantage of the innate human capacity for reasoning about solid objects by treating the characters as solid 3D objects that follow common laws of overlap among solid objects. In accordance with these embodiments, humans may be able to mentally disentangle the characters by reasoning about character behaviors in the third dimension. Embodiments in which CAPTCHAs that include projections on virtual 3D surfaces and/or virtual 3D objects may take advantage of the ability of humans to understand perspective. For instance, the projections and/or virtual 3D objects may have physical interpretations that automated systems are unable (or less likely) to understand.

### II. Example Embodiments

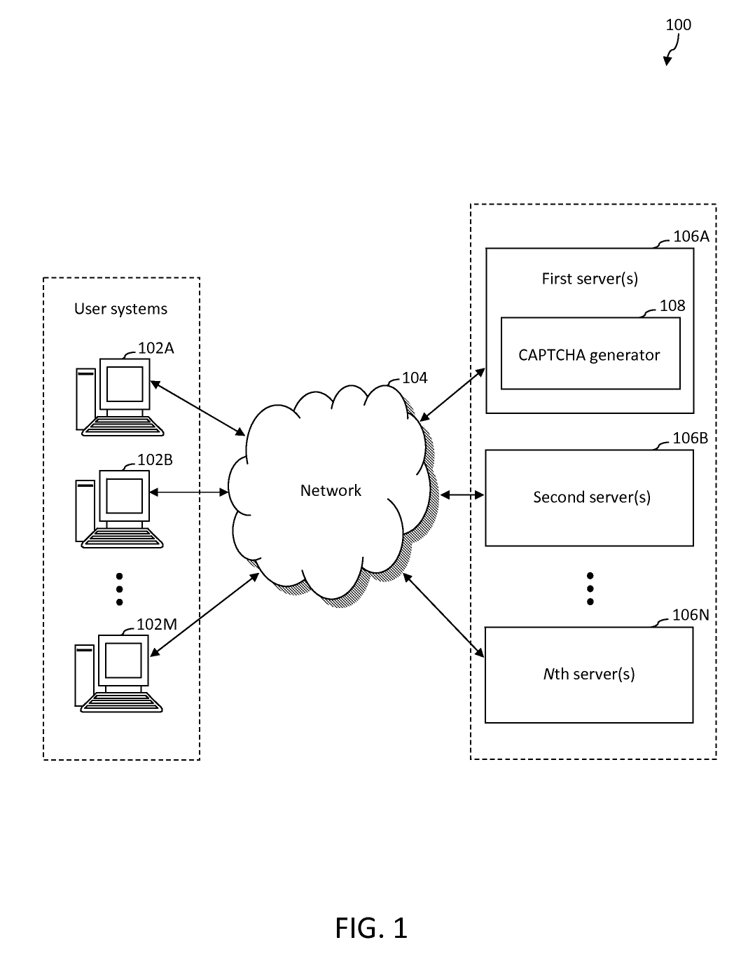

FIG. 1 is a block diagram of an example computer system 100 in accordance with an embodiment described herein. Generally speaking, computer system 100 operates to provide information to users in response to requests (e.g., hypertext transfer protocol (HTTP) requests) that are provided by the users. The information may include Web pages, images, other types of files, output of executables, etc. Computer system 100 further operates to provide CAPTCHAs to users who attempt to access such information in order to authorize the users to access the information. In accordance with example embodiments, computer system 100 is configured to provide CAPTCHAs that include overlapped characters, projections on virtual three-dimensional (3D) surfaces, and/or virtual 3D objects to the users.

As shown in FIG. 1, computer system 100 includes a plurality of user systems 102A-102M, a network 104, and a plurality of servers 106A-106N. Communication among user systems 102A-102M and servers 106A-106N is carried out over network 104 using well-known network communication protocols. Network 104 may be a wide-area network (e.g., the Internet), a local area network (LAN), another type of network, or a combination thereof.

User systems 102A-102M are computers or other processing systems, each including one or more processors, that are capable of communicating with servers 106A-106N. User systems 102A-102M are capable of accessing sites (e.g., Web sites) hosted by servers 104A-104N, so that user systems 102A-102M may access information that is available via the sites. User systems 102A-102M are configured to provide requests (e.g., hypertext transfer protocol (HTTP) requests) to servers 106A-106N for requesting information stored on (or otherwise accessible via) servers 106A-106N. For instance, a user may initiate a request for information using a client (e.g., a Web crawler, a Web browser, a non-Web-enabled client, etc.) deployed on a user system 102 that is owned by or otherwise accessible to the user.

Servers 106A-106N are computers or other processing systems, each including one or more processors, that are capable of communicating with user systems 102A-102M. Servers 106A-106N are configured to host respective sites (e.g., Web sites), so that the sites are accessible to users of computer system 100. Servers 106A-106N are further configured to provide information to users in response to receiving requests (e.g., HTTP requests) from the users.

First server(s) 106A includes a CAPTCHA generator 108. CAPTCHA generator 108 is configured to generate CAPTCHAs that include overlapped characters, projections on virtual 3D surfaces, and/or virtual 3D objects. Further detail regarding techniques for generating CAPTCHAs that include overlapped characters, projections on virtual 3D surfaces, and/or virtual 3D objects is provided in the following discussion. CAPTCHA generator 108 is further configured to provide such CAPTCHAs to users who attempt to access information that is stored on (or otherwise accessible via) first server(s) 106A, so that the users may be authorized to receive the information. For example, CAPTCHA generator 108 may provide the information to the users only if the users solve the CAPTCHAs that are provided to the users. In accordance with this example, a user may solve a CAPTCHA by identifying characters and/or a 3D object that is included in the CAPTCHA.

First server(s) 106A is shown to include CAPTCHA generator 108 for illustrative purposes. It will be recognized that any one or more of servers 106A-106N may include a CAPTCHA generator, such as CAPTCHA generator 108. It will be further recognized that any one or more user systems 102A-102M may communicate with any one or more servers 106A-106N. Although user systems 102A-102M are depicted as desktop computers in FIG. 1, persons skilled in the relevant art(s) will appreciate that user systems 102A-102M may include any client-enabled system or device, including but not limited to a laptop computer, a personal digital assistant, a cellular telephone, etc.

A. CAPTCHAs that Include Overlapped Characters

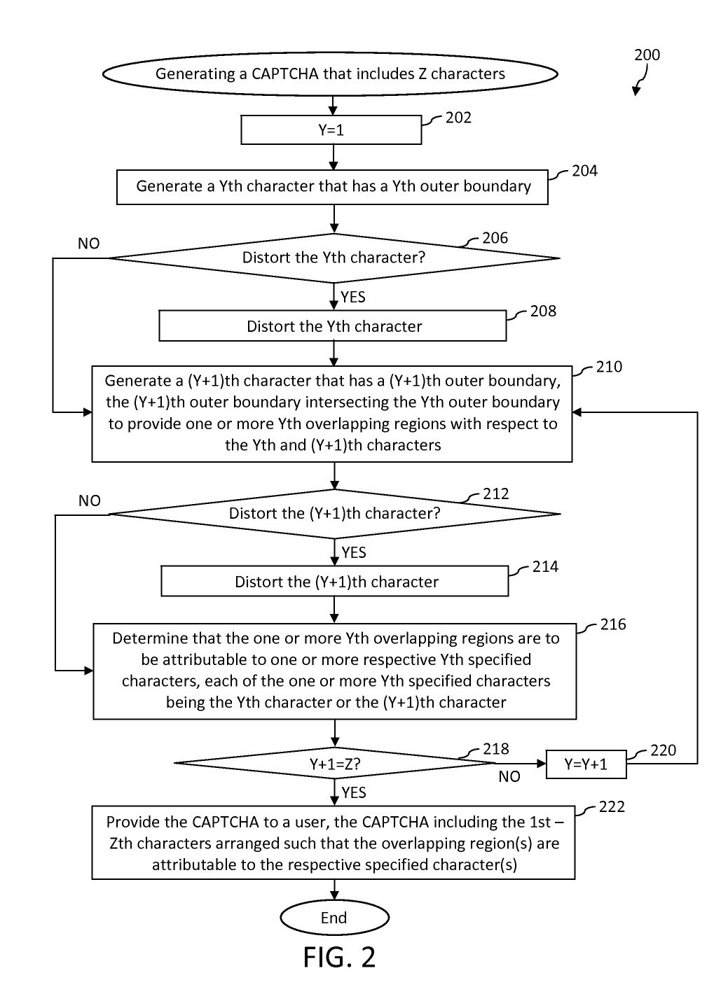

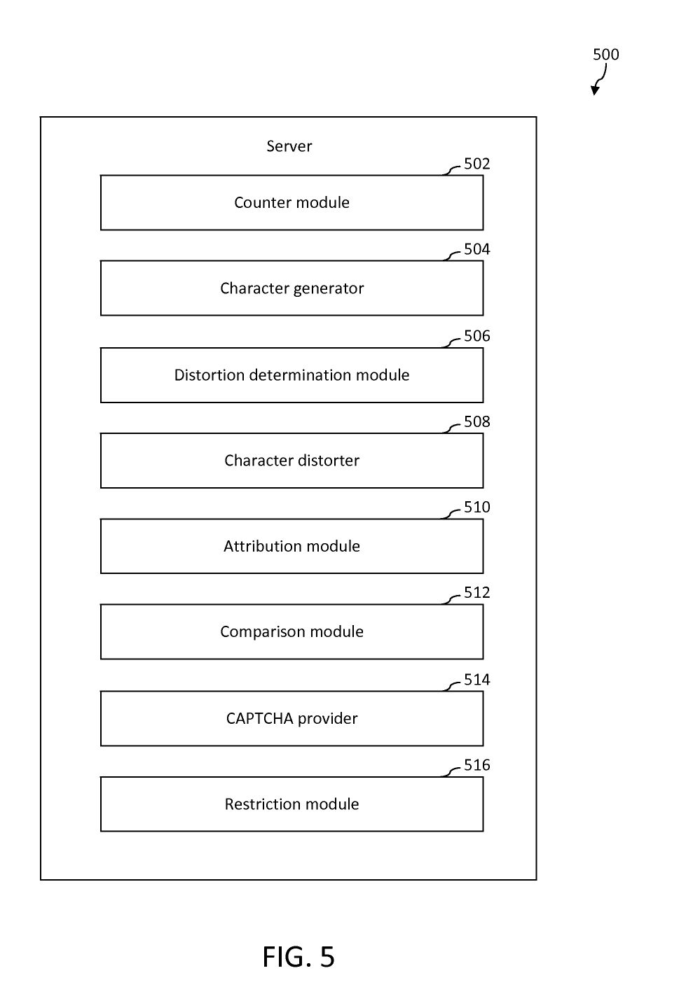

FIGS. 2-4 depict flowcharts 200, 300, and 400 of example methods of generating a CAPTCHA that includes overlapped characters in accordance with embodiments described herein. Flowcharts 200, 300, and 400 may be performed by any one or more of servers 106A-106N of computer system 100 shown in FIG. 1, for example. For illustrative purposes, flowcharts 200, 300, and 400 are described with respect to a server 500 shown in FIG. 5, which is an example of a server 106, according to an embodiment. As shown in FIG. 5, server 500 includes a counter module 502, a character generator 504, a distortion determination module 506, a character distorter 508, an attribution module 510, a comparison module 512, a CAPTCHA provider 514, and restriction module 516. Further structural and operational embodiments will be apparent to persons skilled in the relevant art(s) based on the discussion regarding flowcharts 200, 300, and 400.

As shown in FIG. 2, the method of flowchart 200 pertains to generating a CAPTCHA that includes Z characters. Z is an integer that is greater than or equal to two. The method of flowchart 200 begins at step 202. In step 202, a variable Y is set to equal one. In an example implementation, counter module 502 sets the variable Y to equal one.

At step 204, a Yth character is generated that has a Yth outer boundary. For example, the Yth character may be randomly generated, though the scope of the example embodiments is not limited in this respect. In accordance with this example, the Yth character may be randomly generated from a predetermined set of characters (e.g., lower case letters a through z, upper case letters A through Z, letters of languages other than English, numbers 0 through 9, punctuation characters, etc.). In an example implementation, character generator 504 generates the Yth character.

At step 206, a determination is made whether the Yth character is to be distorted. In an example implementation, distortion determination module 506 determines whether the Yth character is to be distorted. If the Yth character is to be distorted, flow continues to step 208. Otherwise, flow continues to step 210.

At step 208, the Yth character is distorted. For example, the Yth character may be stretched, twisted, compressed, rotated, sheared, curved (e.g., squiggled), blurred, obscured, etc. In another example, an angle between lines of the Yth character may be changed. For instance, the angle between two lines that form an “L” may be reduced so that the L is slanted. In accordance with this example, the lines need not necessarily be straight lines. For instance, one or both of the lines between which the angle is defined may be curved. In an example implementation, character distorter distorts the Yth character.

At step 210, a (Y+1)th character is generated that has a (Y+1)th outer boundary. For instance, the (Y+1)th character may be randomly generated, though the scope of the example embodiments is not limited in this respect. The (Y+1)th outer boundary intersects the Yth outer boundary to provide one or more Yth overlapping regions with respect to the Yth and (Y+1)th characters. In an example implementation, character generator 504 generates the (Y+1)th character.

At step 212, a determination is made whether the (Y+1)th character is to be distorted. In an example implementation, distortion determination module 506 determines whether the (Y+1)th character is to be distorted.

At step 214, the (Y+1)th character is distorted. In an example implementation, character distorter distorts the (Y+1)th character.

At step 216, a determination is made that the one or more Yth overlapping regions are to be attributable to one or more respective Yth specified characters. Each of the one or more Yth specified characters is the Yth character or the (Y+1)th character. For example, some Yth overlapping regions may be attributable to the Yth character, while other Yth overlapping regions may be attributable to the (Y+1)th character. In accordance with this example, the Yth character and the (Y+1)th character may be intertwined. In an example implementation, attribution module 510 determines that the one or more Yth overlapping regions are to be attributable to the one or more respective Yth specified characters.

At step 218, a determination is made whether Y+1=Z. Z represents a number of characters that are to be included in a CAPTCHA. In an example implementation, comparison module 512 determines whether Y+1=Z. If Y+1=Z, flow continues to step 222. Otherwise, flow continues to step 220.

At step 220, the variable Y is incremented by one. In an example implementation, counter module 502 increments the variable Y by one. Upon completion of step 220, flow returns to step 210.

At step 222, the CAPTCHA is provided to a user. The CAPTCHA includes the first character through the Zth character, arranged such that the overlapping region(s) are attributable to the respective specified character(s). For instance, the first overlapping region is attributable to the first specified character; the second overlapping region is attributable to the second specified character; and so on. The first through Zth characters may be arranged substantially horizontally (e.g., from left to right or from right to left), substantially vertically (e.g., from top to bottom or from bottom to top), diagonally, or in another arrangement. In an example implementation, CAPTCHA provider 514 provides the CAPTCHA to the user.

Attributes (e.g., character size, font, etc.) of the Z characters may have any suitable values. For instance, the values of the attributes may be selectable. In accordance with an example embodiment, one or more attribute values of each character are randomly selected. In accordance with this example embodiment, such attribute values may be randomly selected from a predetermined set of attribute values.

In some example embodiments, one or more steps 202, 204, 206, 208, 210, 212, 214, 216, 218, 220, and/or 222 of flowchart 200 may not be performed. Moreover, steps in addition to or in lieu of steps 202, 204, 206, 208, 210, 212, 214, 216, 218, 220, and/or 222 may be performed.

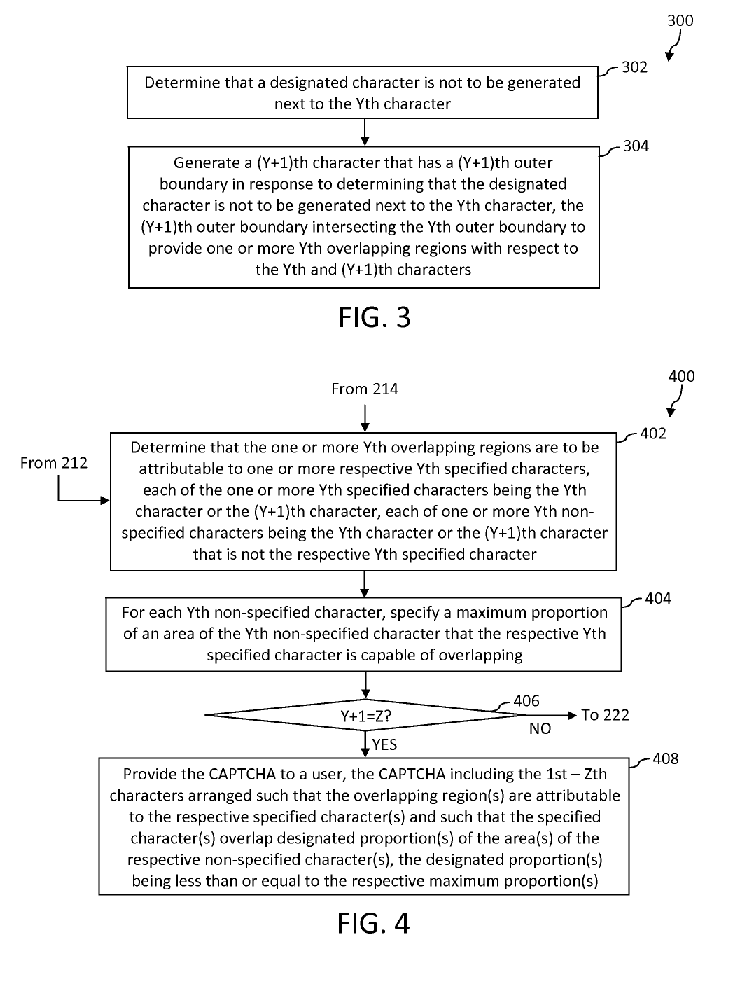

In an example embodiment, instead of performing step 210 of flowchart 200, the steps of flowchart 300 in FIG. 3 are performed. As shown in FIG. 3, flowchart 300 begins at step 302. In step 302, a determination is made that a designated character is not to be generated next to the Yth character. In an example implementation, restriction module 516 determines that the designated character is not to be generated next to the Yth character.

At step 304, a (Y+1)th character that has a (Y+1)th outer boundary is generated in response to determining that the designated character is not to be generated next to the Yth character. The (Y+1)th outer boundary intersects the Yth outer boundary to provide one or more Yth overlapping regions with respect to the Yth and (Y+1)th characters. In an example implementation, character generator 504 generates the (Y+1)th character.

In another example embodiment, instead of performing steps 216, 218, and 222 of flowchart 200, the steps of flowchart 400 in FIG. 4 are performed. As shown in FIG. 4, flowchart 400 begins at step 402. In step 402, a determination is made that the one or more Yth overlapping regions are to be attributable to one or more respective Yth specified characters. Each of the one or more Yth specified characters is the Yth character or the (Y+1)th character. Each of one or more Yth non-specified characters is the Yth character or the (Y+1)th character that is not the respective Yth specified character.

At step 404, for each Yth non-specified character, a maximum proportion of an area of the Yth non-specified character that the respective Yth specified character is capable of overlapping is specified. In an example implementation, restriction module 516 specifies, for each Yth non-specified character, the maximum proportion of the area of the Yth non-specified character that the respective Yth specified character is capable of overlapping.

At step 406, a determination is made whether Y+1=Z. In an example implementation, comparison module 512 determines whether Y+1=Z. If Y+1=Z, flow continues to step 408. Otherwise, flow continues to step 222 of flowchart 200.

At step 408, the CAPTCHA is provided to a user. The CAPTCHA includes the 1st-Zth characters arranged such that the overlapping region(s) are attributable to the respective specified character(s) and such that the specified character(s) overlap designated proportion(s) of the area(s) of the respective non-specified character(s). The designated proportion(s) are less than or equal to the respective maximum proportion(s). In an example implementation, CAPTCHA provider 514 provides the CAPTCHA to the user.

In accordance with an example embodiment, if a (Y+1)th character is distorted at step 214 such that a relationship between an area of a respective Yth overlapping region and an area of a respective Yth non-specified character exceeds the maximum proportion of the area of the Yth non-specified character that a respective Yth specified character is capable of overlapping, the area of the Yth overlapping region is reduced so that a respective designated proportion of the area of the Yth non-specified character is less than or equal to the maximum proportion. In accordance with this example embodiment, providing the CAPTCHA to the user at step 408 is performed in response to reducing the area of the Yth overlapping region.

It will be recognized that server 500 may not include one or more of counter module 502, character generator 504, distortion determination module 506, character distorter 508, attribution module 510, comparison module 512, CAPTCHA provider 514, and/or restriction module 516. Furthermore, server 500 may include modules in addition to or in lieu of counter module 502, character generator 504, distortion determination module 506, character distorter 508, attribution module 510, comparison module 512, CAPTCHA provider 514, and/or restriction module 516. Moreover, server 500 may be implemented as one or more servers.

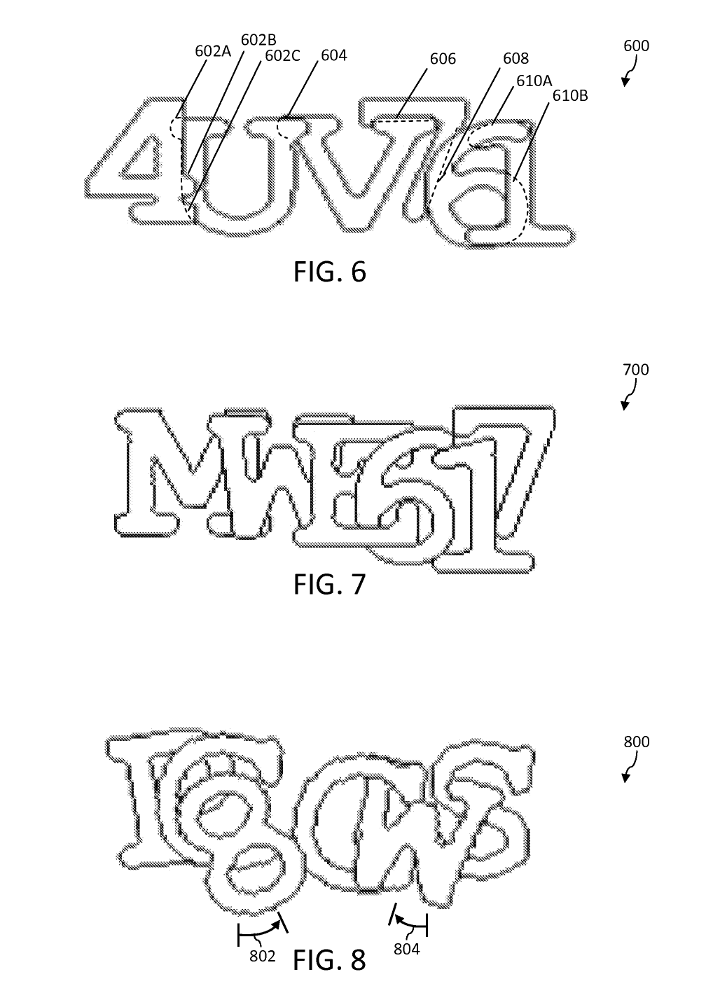

FIGS. 6-8 show example CAPTCHAs 600, 700, and 800 that include overlapped characters in accordance with embodiments described herein. As shown in FIG. 6, CAPTCHA 600 includes six characters (4, U, V, 7, 6, and 1) that are arranged to provide overlapping regions 602A, 602B, 602C, 604, 606, 608, 610A, and 610B. For example, the “4” and the “U” overlap to provide overlapping regions 602A, 602B, and 602C. Overlapping regions 602A, 602B, and 602C are said to be attributable to the “4” because the “4” overlaps the “U” with respect to overlapping regions 602A, 602B, and 602C.

The “U” and the “V” overlap to provide overlapping region 604. Overlapping region 604 is said to be attributable to the “U” because the “U” overlaps the “V” with respect to overlapping region 604.

The “V” and the “7” overlap to provide overlapping region 606. Overlapping region 606 is said to be attributable to the “V because the “V” overlaps the “7” with respect to overlapping region 606.

The “7” and the “6” overlap to provide overlapping region 608. Overlapping region 608 is said to be attributable to the “6” because the “6” overlaps the “7” with respect to overlapping region 608.

The “6” and the “1” overlap to provide overlapping regions 610A and 610B. Overlapping region 610A is said to be attributable to the “6” because the “6” overlaps the “1” with respect to overlapping region 610A. Overlapping region 610B is said to be attributable to the “1” because the “1” overlaps the “6” with respect to overlapping region 610B.

CAPTCHA 600 is shown to include six characters for illustrative purposes and is not intended to be limiting. It will be recognized that CAPTCHA 600 may include any number of characters arranged in any order. Moreover, each of the characters in CAPTCHA 600 is shown to provide at least one overlapping region with an adjacent character. Persons skilled in the relevant art(s) will recognize that one or more of the characters in a CAPTCHA (e.g., CAPTCHA 600) may not necessarily provide an overlapping region with another character. For example, as shown in FIG. 7, CAPTCHA 700 includes six characters (M, W, E, 6, 1, and 7), of which the “1” and the “7” do not provide an overlapping region with another character. For instance, neither the “1” nor the “7” overlaps another character, and no character overlaps the “1” or the “7”.

As shown in FIG. 8, CAPTCHA 800 includes 6 characters (P, C, 8, G, W, and S), each of which is distorted. In particular, each of the characters of CAPTCHA 800 is rotated. For example, the “8” in CAPTCHA 800 is rotated counterclockwise to an extent that is indicated by arrow 802. In another example, the “W” in CAPTCHA 800 is rotated clockwise to an extent that is indicated by arrow 804. Rotating characters is merely one example way of distorting the characters. It will be recognized that characters of a CAPTCHA (e.g., CAPTCHA 800) may be distorted in way(s) in addition to or in lieu of rotating the characters. For instance, different characters may be distorted in different ways. Moreover, characters in a CAPTCHA need not necessarily be distorted.

B. CAPTCHAs that Include Projections on Virtual 3D Surfaces

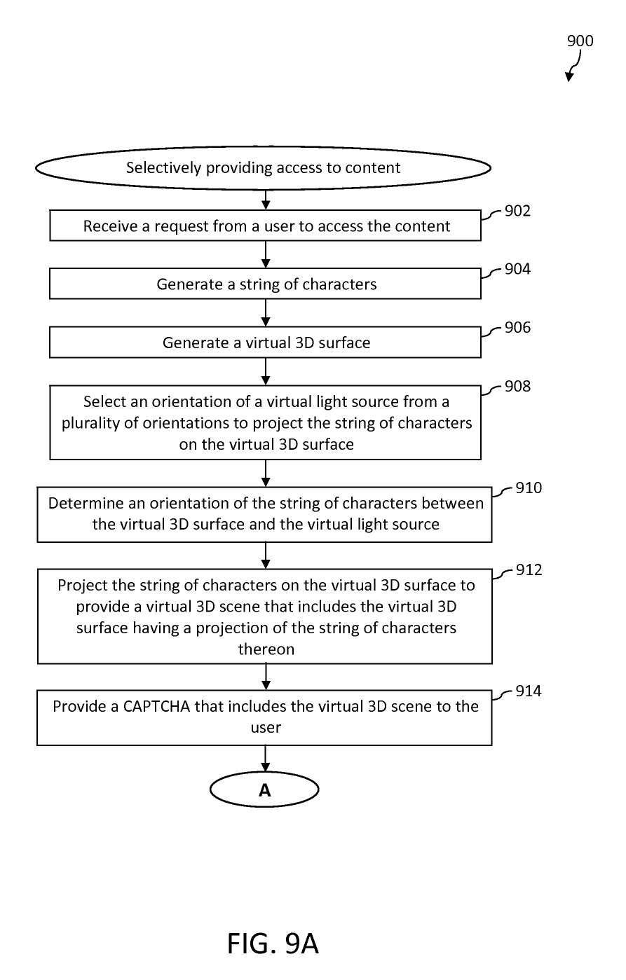

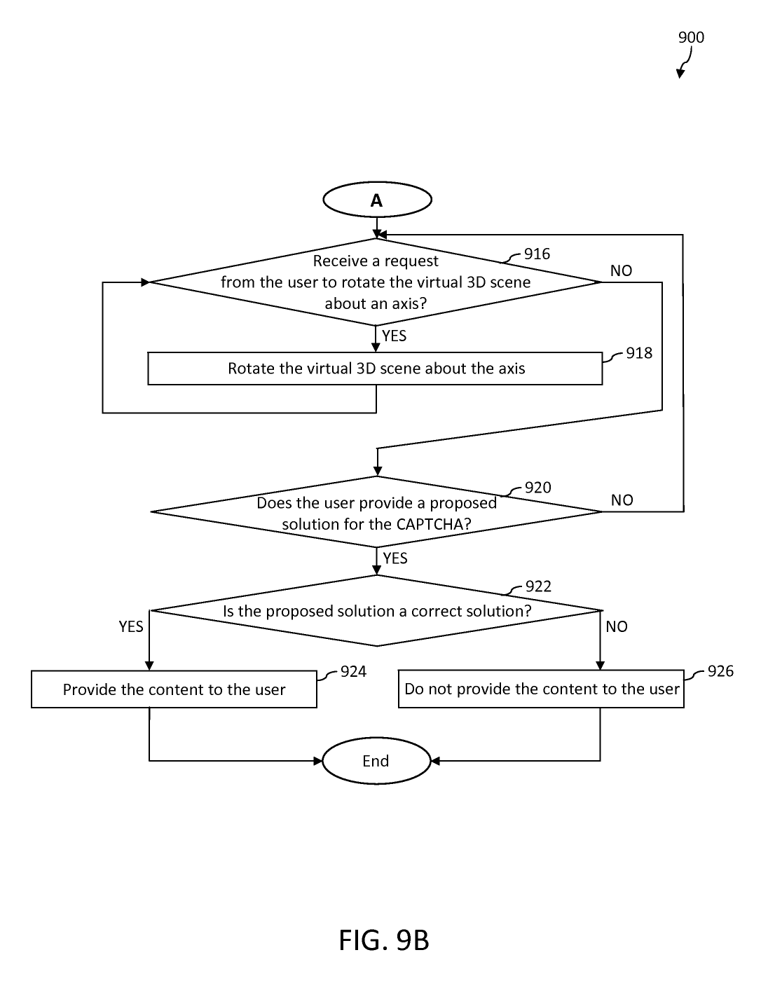

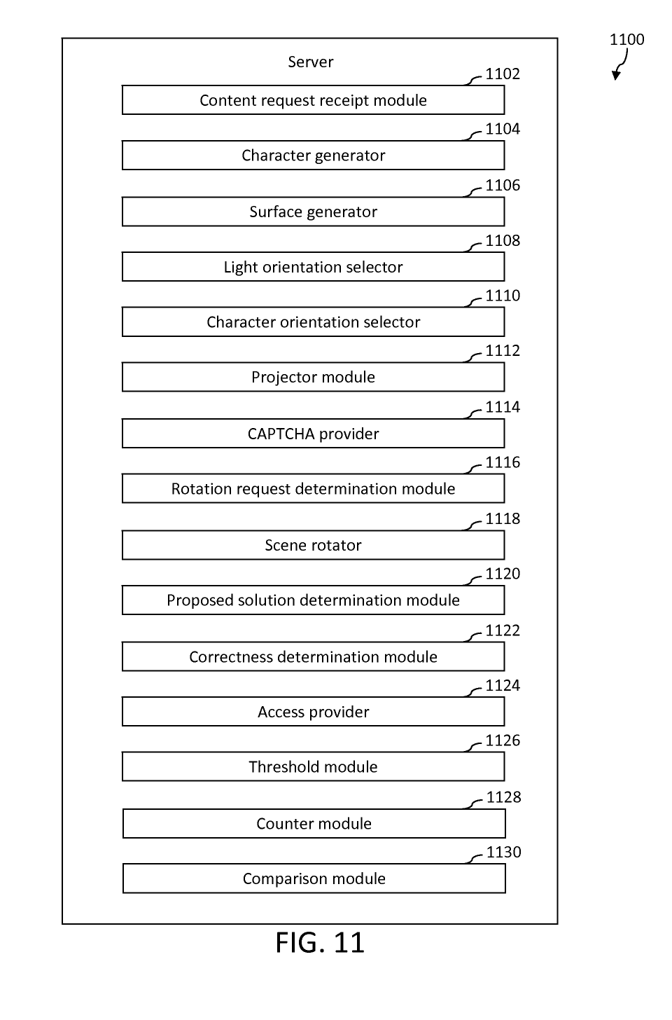

FIGS. 9A-9B show respective portions of a flowchart 900 of an example method of selectively providing access to content in accordance with an embodiment described herein. Flowchart 900 may be performed by any one or more of servers 106A-106N of computer system 100 shown in FIG. 1, for example. For illustrative purposes, flowchart 900 is described with respect to a server 1100 shown in FIG. 11, which is an example of a server 106, according to an embodiment. As shown in FIG. 11, server 1100 includes a content request receipt module 1102, a character generator 1104, a surface generator 1106, a light orientation selector 1108, a character orientation selector 1110, a projector module 1112, a CAPTCHA provider 1114, a rotation request determination module 1116, a scene rotator 1118, a proposed solution determination module 1120, a correctness determination module 1122, an access provider 1124, a threshold module 1126, a counter module 1128, and a comparison module 1130. Further structural and operational embodiments will be apparent to persons skilled in the relevant art(s) based on the discussion regarding flowchart 900.

As shown in FIG. 9A, the method of flowchart 900 begins at step 902. In step 902, a request is received from a user to access content. In an example implementation, content request receipt module 1102 receives the request from the user.

At step 904, a string of characters is generated. For instance, the string of characters may be randomly generated, though the scope of the example embodiments is not limited in this respect. In an example implementation, character generator 1104 generates the string of characters.

At step 906, a virtual three-dimensional (3D) surface is generated. For instance, the virtual 3D surface may be randomly generated, though the scope of the example embodiments is not limited in this respect. In an example implementation, surface generator 1106 generates the virtual 3D surface.

At step 908, an orientation of a virtual light source is selected from a plurality of orientations to project the string of characters on the virtual 3D surface. For instance, the orientation of the virtual light source may include a distance of the virtual light source from the virtual 3D surface, a distance of the virtual light source from the string of characters, a direction in which the virtual light source is directed, etc. In an example implementation, light orientation selector 1108 selects the orientation of the virtual light source.

At step 910, an orientation of the string of characters between the virtual 3D surface and the virtual light source is determined For instance, the orientation of the string of characters may include a distance of the string of characters from the virtual 3D surface; a distance of the string of characters from the virtual light source; a yaw, a pitch, and/or a roll of the string of characters; etc. In an example implementation, character orientation selector 1110 determines the orientation of the string of characters.

At step 912, the string of characters is projected on the virtual 3D surface to provide a virtual 3D scene that includes the virtual 3D surface having a projection of the string of characters thereon. In an example implementation, projector module 1112 projects the string of characters on the virtual 3D surface to provide the virtual 3D scene.

At step 914, a CAPTCHA that includes the virtual 3D scene is provided to the user. In an example implementation, CAPTCHA provider 1114 provides the CAPTCHA that includes the virtual 3D scene to the user. Upon completion of step 914, flow continues to step 916, which is shown in FIG. 9B.

In accordance with an example embodiment, the CAPTCHA that is provided to the user includes a request that the user provide a proposed solution for the CAPTCHA. For instance, the CAPTCHA may include a request that the user identify (e.g., transcribe) the string of characters. In accordance with another example embodiment, a request that the user provide a proposed solution for the CAPTCHA is provided to the user in addition to (e.g., separately from) the CAPTCHA.

At step 916, a determination is made whether a request is received from the user to rotate the virtual 3D scene about an axis. In an example implementation, rotation request determination module 1116 determines whether a request to rotate the virtual 3D scene about an axis is received from the user. If such a request is received from the user, flow continues to step 918. Otherwise, flow continues to step 920.

At step 918, the virtual 3D scene is rotated about the axis. For instance, the axis about which the virtual 3D scene is rotated may be specified from among a plurality of axes by the request that is received from the user. In an example implementation, scene rotator 1118 rotates the virtual 3D scene about the axis. Upon completion of step 918, flow returns to step 916.

At step 920, a determination is made whether the user provides a proposed solution for the CAPTCHA. For instance, the proposed solution may include a string of characters that is intended to be the same as the string of characters that is included in the CAPTCHA. In an example implementation, proposed solution determination module 1120 determines whether the user provides a proposed solution for the CAPTCHA. If the user provides a proposed solution for the CAPTCHA, flow continues to step 922. Otherwise, flow returns to step 916.

At step 922, a determination is made whether the proposed solution is a correct solution. For instance, a determination may be made whether a string of characters that is entered by the user is the same as the string of characters that is included in the CAPTCHA. In an example implementation, correctness determination module 1122 determines whether the proposed solution is a correct solution. If the proposed solution is a correct solution, flow continues to step 924. Otherwise, flow continues to step 926.

At step 924, the content is provided to the user. In an example implementation, access provider 1124 provides the content to the user. Upon completion of step 924, flowchart 900 ends.

At step 926, the content is not provided to the user. In an example implementation, access provider 1124 does not provide the content to the user. Upon completion of step 926, flowchart 900 ends.

In some example embodiments, one or more steps 902, 904, 906, 908, 910, 912, 914, 916, 918, 920, 922, 924, and/or 926 of flowchart 900 may not be performed. Moreover, steps in addition to or in lieu of steps 902, 904, 906, 908, 910, 912, 914, 916, 918, 920, 922, 924, and/or 926 may be performed.

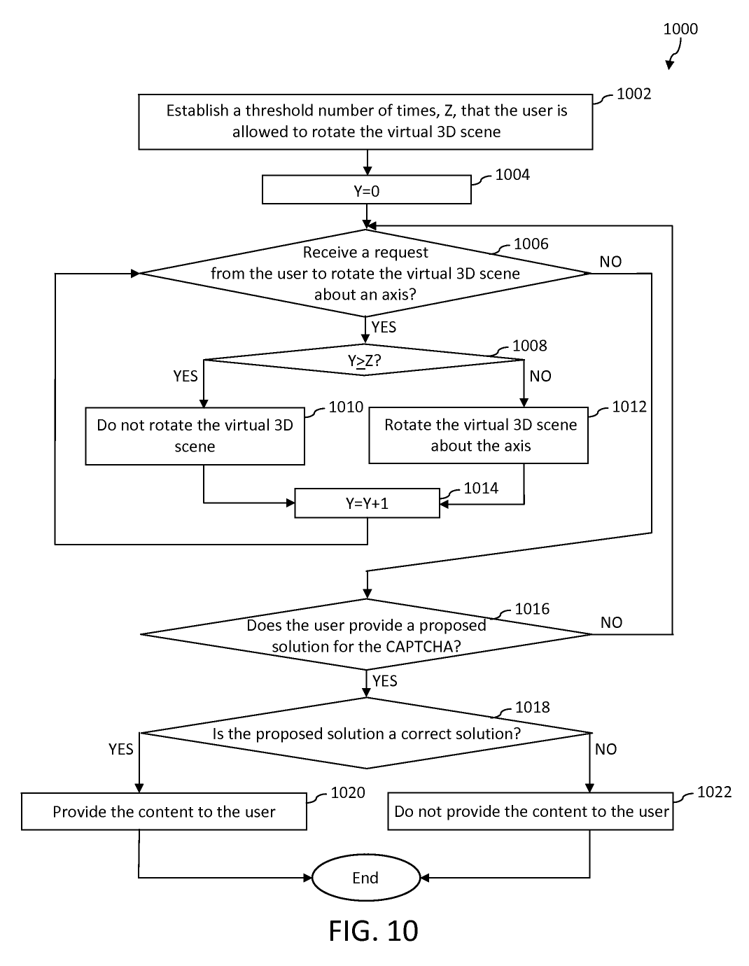

In an example embodiment, instead of performing steps 916, 918, 920, 922, 924, and 926 of flowchart 900 (i.e., the steps shown in FIG. 9B), the steps of flowchart 1000 in FIG. 10 are performed. As shown in FIG. 10, flowchart 1000 begins at step 1002. In step 1002, a threshold number of times, Z, that the user is allowed to rotate the virtual 3D scene is established. In an example implementation, threshold module 1126 establishes the threshold number of times, Z.

At step 1004, a variable Y is set to equal zero. In an example implementation, counter module 1128 sets the variable Y to equal zero.

At step 1006, a determination is made whether a request is received from the user to rotate the virtual 3D scene about an axis. In an example implementation, rotation request determination module 1116 determines whether a request to rotate the virtual 3D scene about an axis is received from the user. If such a request is received from the user, flow continues to step 1008. Otherwise, flow continues to step 1016.

At step 1008, a determination is made whether the variable Y is greater than or equal to the threshold number of times, Z. In an example implementation, comparison module 1130 determines whether the variable Y is greater than or equal to the threshold number of times, Z. If the variable Y is greater than or equal to the threshold number of times, Z, flow continues to step 1010. Otherwise, flow continues to step 1012.

At step 1010, the virtual 3D scene is not rotated. In an example implementation, scene rotator 1118 does not rotate the virtual 3D scene. Upon completion of step 1010, flow continues to step 1014.

At step 1012, the virtual 3D scene is rotated about the axis. In an example implementation, scene rotator 1118 rotates the virtual 3D scene about the axis. Upon completion of step 1012, flow continues to step 1014.

At step 1014, the variable Y is incremented by one. In an example implementation, counter module 1128 increments the variable Y by one. Upon completion of step 1014, flow returns to step 1006.

At step 1016, a determination is made whether the user provides a proposed solution for the CAPTCHA. In an example implementation, proposed solution determination module 1120 determines whether the user provides a proposed solution for the CAPTCHA. If the user provides a proposed solution for the CAPTCHA, flow continues to step 1018. Otherwise, flow returns to step 1006.

At step 1018, a determination is made whether the proposed solution is a correct solution. In an example implementation, correctness determination module 1122 determines whether the proposed solution is a correct solution. If the proposed solution is a correct solution, flow continues to step 1020. Otherwise, flow continues to step 1022.

At step 1020, the content is provided to the user. In an example implementation, access provider 1124 provides the content to the user. Upon completion of step 1020, flowchart 1000 ends.

At step 1022, the content is not provided to the user. In an example implementation, access provider 1124 does not provide the content to the user. Upon completion of step 1022, flowchart 1000 ends.

In some example embodiments, one or more steps 1002, 1004, 1006, 1008, 1010, 1012, 1014, 1016, 1018, 1020, and/or 1022 of flowchart 1000 may not be performed. Moreover, steps in addition to or in lieu of steps 1002, 1004, 1006, 1008, 1010, 1012, 1014, 1016, 1018, 1020, and/or 1022 may be performed.

It will be recognized that server 1100 may not include one or more of content request receipt module 1102, character generator 1104, surface generator 1106, light orientation selector 1108, character orientation selector 1110, projector module 1112, CAPTCHA provider 1114, rotation request determination module 1116, scene rotator 1118, proposed solution determination module 1120, correctness determination module 1122, access provider 1124, threshold module 1126, counter module 1128, and/or comparison module 1130. Furthermore, server 1100 may include modules in addition to or in lieu of content request receipt module 1102, character generator 1104, surface generator 1106, light orientation selector 1108, character orientation selector 1110, projector module 1112, CAPTCHA provider 1114, rotation request determination module 1116, scene rotator 1118, proposed solution determination module 1120, correctness determination module 1122, access provider 1124, threshold module 1126, counter module 1128, and/or comparison module 1130. Moreover, server 1100 may be implemented as one or more servers.

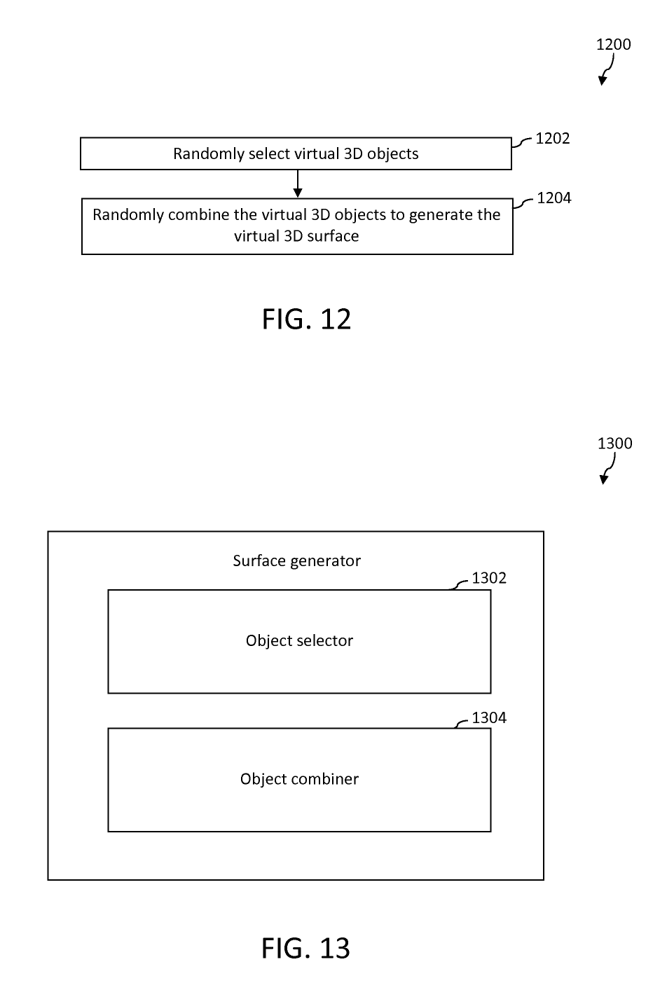

FIG. 12 shows a flowchart 1200 of an example method of generating a virtual three-dimensional (3D) surface in accordance with an embodiment described herein. Flowchart 1200 may be performed by surface generator 1106 of server 1100 shown in FIG. 11, for example. For illustrative purposes, flowchart 1200 is described with respect to a surface generator 1300 shown in FIG. 13, which is an example of a surface generator 1106, according to an embodiment. As shown in FIG. 13, surface generator 1300 includes an object selector 1302 and an object combiner 1304. Further structural and operational embodiments will be apparent to persons skilled in the relevant art(s) based on the discussion regarding flowchart 1200.

As shown in FIG. 12, the method of flowchart 1200 begins at step 1202. In step 1202, virtual 3D objects are randomly selected. In an example implementation, object selector 1302 randomly selects the virtual 3D objects.

At step 1204, the virtual 3D objects are randomly combined to generate the virtual 3D surface. In an example implementation, object combiner 1304 randomly combines the virtual 3D objects.

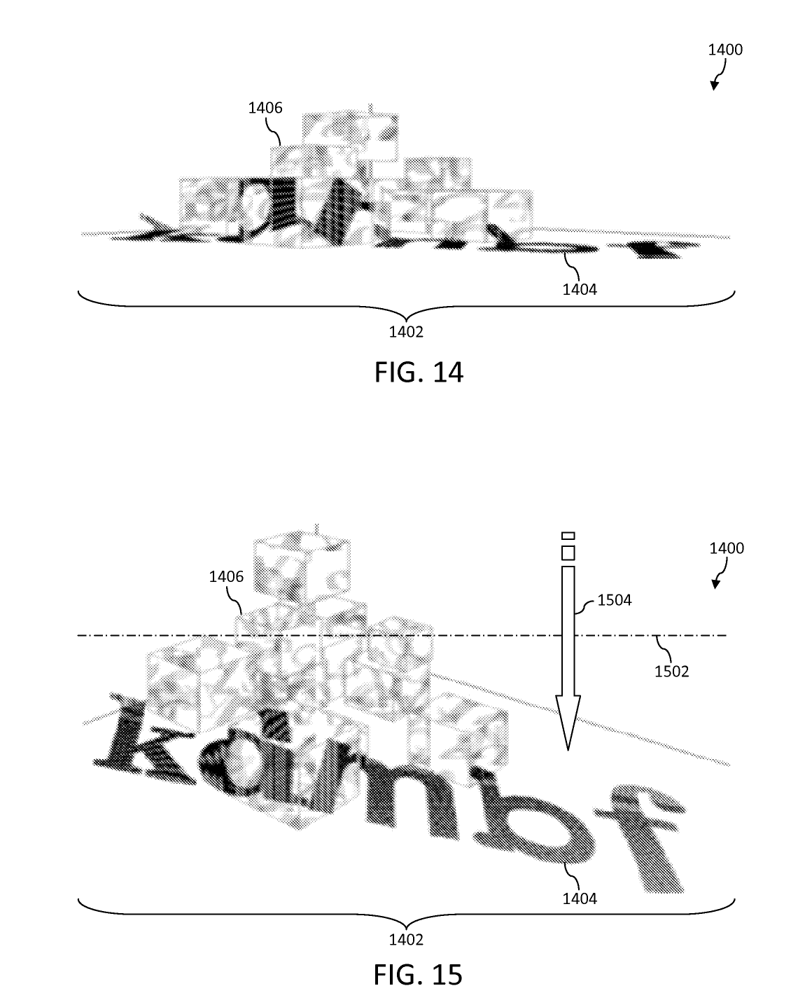

FIGS. 14-17 show example CAPTCHAs 1400, 1600, and 1700 that include projections on virtual 3D surfaces in accordance with embodiments described herein. As shown in FIG. 14, CAPTCHA 1400 includes a virtual three-dimensional (3D) scene 1402. Virtual 3D scene 1402 includes a string of characters 1404 that is projected on a virtual 3D surface 1406. The string of characters 1404 is shown to include five characters (k, d, m, b, and f) for illustrative purposes. It will be recognized that string of characters 1404 may include any suitable number of characters.

In accordance with some example embodiments, a user is given an opportunity to provide instruction(s) that enable a CAPTCHA generator (e.g., CAPTCHA generator 108) to rotate a virtual 3D scene that is included in a CAPTCHA. For instance, rotating the virtual 3D scene may facilitate identification of characters that are included in the virtual 3D scene. For example, as shown in FIG. 15, virtual 3D scene 1402 is rotated about an axis 1502 in a direction that is indicated by arrow 1504 in response to an instruction that is received from a user. The user may provide the instruction using an input device, such as a keyboard, touch screen, pointing device, etc. For instance, the user may drag a cursor downward with respect to CAPTCHA 1400 as indicated by arrow 1504 to cause virtual 3D scene 1402 to be rotated as depicted in FIG. 15. It will be recognized that the characters k, d, m, b, and f of character string 1404 are more easily identifiable in FIG. 15, as compared to FIG. 14.

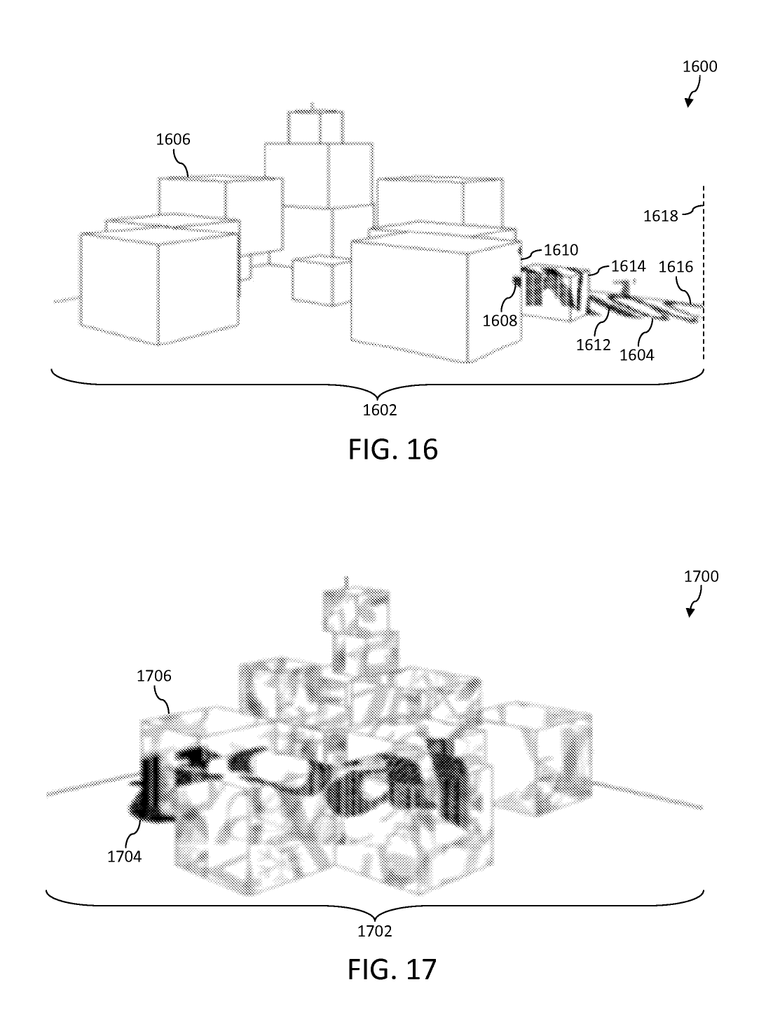

As shown in FIG. 16, CAPTCHA 1600 includes a virtual 3D scene 1602. Virtual 3D scene 1602 includes a string of characters 1604 that is projected on a virtual 3D surface 1606, such that some characters in character string 1604 are at least partially obscured. For example, a character 1608 of character string 1604 is sheared at an edge 1610 of virtual 3D surface 1606, such that a substantial portion of character 1608 is obscured.

In another example, a character 1612 of character string 1604 is hidden behind a portion 1614 of virtual 3D surface 1606. Accordingly, portion 1614 of virtual 3D surface 1606 obscures a portion of character 1612.

In yet another example, a character 1616 of character string 1604 is sheared at a boundary 1618 that defines an outer perimeter of CAPTCHA 1600. Character string 1604 may include characters that are beyond boundary 1618, though the scope of the example embodiments is not limited in this respect. For instance, characters of character string 1604 that are beyond boundary 1618 may be identifiable only if virtual 3D scene 1602 is rotated to bring those characters within the outer perimeter of CAPTCHA 1600 (e.g., to the left of boundary 1618). For instance, a user may rotate virtual 3D scene downward and/or to the left so that all characters of character string 1604 may be identified.

In accordance with other example embodiments, a user is not given an opportunity to provide instruction(s) that enable a CAPTCHA generator to rotate a virtual 3D scene that is included in a CAPTCHA. For example, as shown in FIG. 17, CAPTCHA 1700 includes a virtual 3D scene 1702. Virtual 3D scene 1702 includes a string of characters 1704 that is projected on a virtual 3D surface 1706. The string of characters 1704 is shown to include the word “goal” for illustrative purposes. A user may be required to transcribe the word “goal” without being able to rotate virtual 3D scene 1702, so that the user may be authorized to access content.

C. CAPTCHAs that Include Virtual 3D Objects

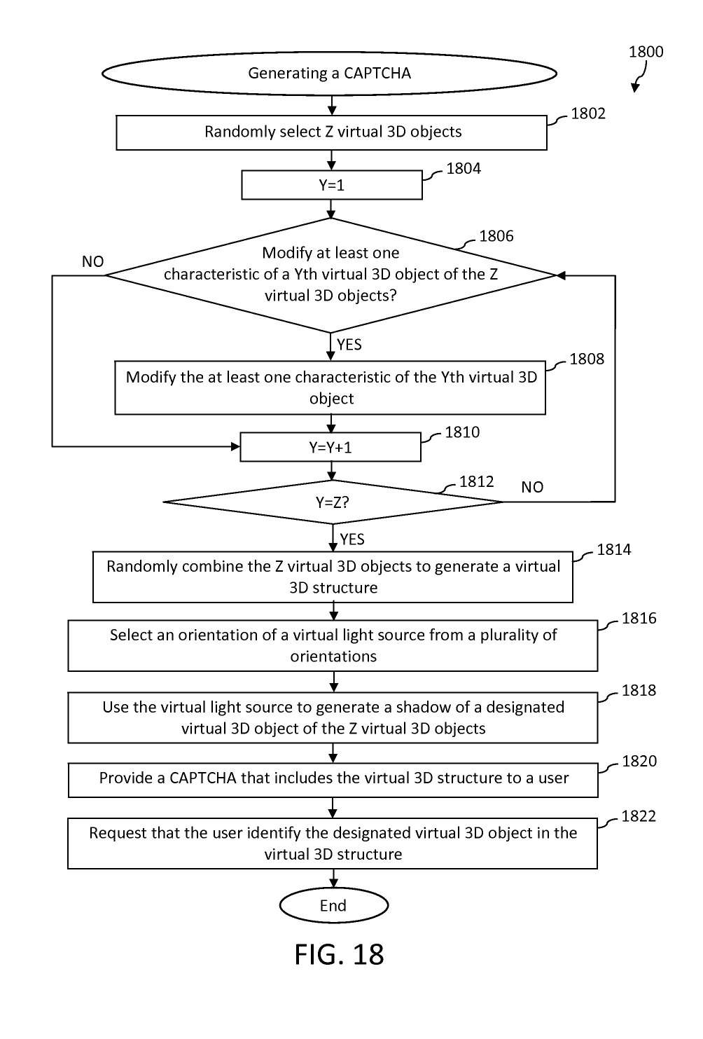

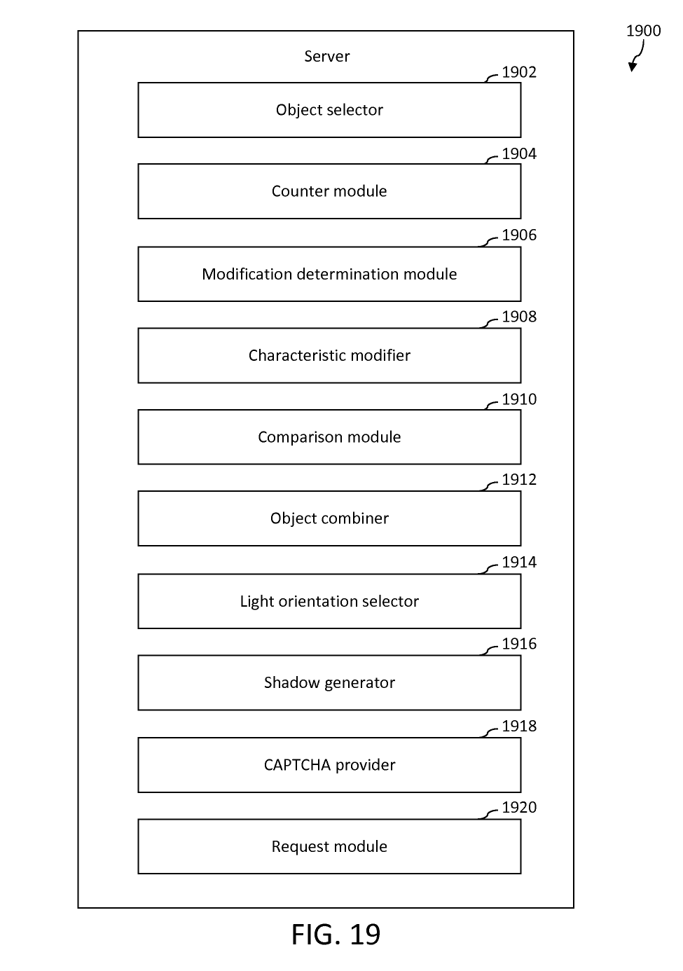

FIG. 18 depicts a flowchart 1800 of an example method of generating a CAPTCHA that includes virtual 3D objects in accordance with an embodiment described herein. Flowchart 1800 may be performed by any one or more of servers 106A-106N of computer system 100 shown in FIG. 1, for example. For illustrative purposes, flowchart 1800 is described with respect to a server 1900 shown in FIG. 19, which is an example of a server 106, according to an embodiment. As shown in FIG. 19, server 1900 includes an object selector 1902, a counter module 1904, a modification determination module 1906, a characteristic modifier 1908, a comparison module 1910, an object combiner 1912, a light orientation selector 1914, a shadow generator 1916, a CAPTCHA provider 1918, and a request module 1920. Further structural and operational embodiments will be apparent to persons skilled in the relevant art(s) based on the discussion regarding flowchart 1800.

As shown in FIG. 18, the method of flowchart 1800 begins at step 1802. In step 1802, Z virtual three-dimensional (3D) objects are randomly selected. The variable Z is an integer. In an example implementation, object selector 1902 randomly selects the Z virtual 3D objects.

At step 1804, a variable Y is set to equal one. In an example implementation, counter module 1904 sets the variable Y to equal one.

At step 1806, a determination is made whether at least one characteristic of a Yth virtual 3D object of the Z virtual 3D objects is to be modified. In an example implementation, modification determination module 1906 determines whether at least one characteristic of the Yth virtual 3D object is to be modified. If at least one characteristic of the Yth virtual 3D object is to be modified, flow continues to step 1808. Otherwise, flow continues to step 1810.

At step 1808, at least one characteristic of the Yth virtual 3D object is modified. For example, the Yth virtual 3D object may be twisted, rotated, sheared, curved, blurred, etc. In another example, the height, width, and/or length of the Yth virtual 3D object may be changed. In yet another example, characteristic(s) of the Yth virtual 3D object may be randomly modified, though the scope of the example embodiments is not limited in this respect. In accordance with this example, the characteristic(s) that are modified may be randomly selected from a predetermined set of characteristics. In an example implementation, characteristic modifier 1908 modifies the at least one characteristic of the Yth virtual 3D object.

At step 1810, the variable Y is incremented by one. In an example implementation, counter module 1904 increments the variable Y by one.

At step 1812, a determination is made whether Y=Z. In an example implementation, comparison module 1910 determines whether Y=Z. If Y=Z, flow continues to step 1814. Otherwise, flow returns to step 1806.

At step 1814, the Z virtual 3D objects are randomly combined to generate a virtual 3D structure. In an example implementation, object combiner 1912 randomly combines the Z virtual 3D objects to generate the virtual 3D structure.

In accordance with an example embodiment, randomly combining the Z virtual 3D objects includes obscuring at least a portion of a virtual 3D object by another virtual 3D object. It will be recognized that any number of virtual 3D objects may be partially or entirely obscured by any number of other virtual 3D objects in any manner.

At step 1816, an orientation of a virtual light source is selected from a plurality of orientations. For instance, the orientation of the virtual light source may be randomly selected from the plurality of orientations, though the scope of the example embodiments is not limited in this respect. In an example implementation, light orientation selector 1914 selects the orientation of the virtual light source.

At step 1818, the virtual light source is used to generate a shadow of a designated virtual 3D object of the Z virtual 3D objects. In an example implementation, shadow generator 1916 uses the virtual light source to generate the shadow of the designated virtual 3D object.

At step 1820, a CAPTCHA that includes the virtual 3D structure is provided to a user. For instance, the CAPTCHA may further include the shadow that the virtual light source is used to generated at step 1818. In an example implementation, CAPTCHA provider 1918 provides the CAPTCHA that includes the virtual 3D structure to the user.

At step 1822, a request is made that the user identify the designated virtual 3D object in the virtual 3D structure. In an example implementation, request module 1920 requests that the user identify the designated virtual 3D object in the virtual 3D structure.

In some example embodiments, one or more steps 1802, 1804, 1806, 1808, 1820, and/or 1822 of flowchart 1800 may not be performed. Moreover, steps in addition to or in lieu of steps 1802, 1804, 1806, 1808, 1820, and/or 1822 may be performed.

It will be recognized that server 1900 may not include one or more of object selector 1902, counter module 1904, modification determination module 1906, characteristic modifier 1908, comparison module 1910, object combiner 1912, light orientation selector 1914, shadow generator 1916, CAPTCHA provider 1918, and/or request module 1920. Furthermore, server 1900 may include modules in addition to or in lieu of object selector 1902, counter module 1904, modification determination module 1906, characteristic modifier 1908, comparison module 1910, object combiner 1912, light orientation selector 1914, shadow generator 1916, CAPTCHA provider 1918, and/or request module 1920. Moreover, server 1900 may be implemented as one or more servers.

### III. Other Example Embodiments

It should be noted that CAPTCHA generator 108 of FIG. 1 may include counter module 502, character generator 504, distortion determination module 506, character distorter 508, attribution module 510, comparison module 512, CAPTCHA provider 514, and/or restriction module 516 of FIG. 5; content request receipt module 1102, character generator 1104, surface generator 1106, light orientation selector 1108, character orientation selector 1110, projector module 1112, CAPTCHA provider 1114, rotation request determination module 1116, scene rotator 1118, proposed solution determination module 1120, correctness determination module 1122, access provider 1124, threshold module 1126, counter module 1128, and/or comparison module 1130 of FIG. 11; object selector 1302 and/or object combiner 1304 of FIG. 13; object selector 1902, counter module 1904, modification determination module 1906, characteristic modifier 1908, comparison module 1910, object combiner 1912, light orientation selector 1914, shadow generator 1916, CAPTCHA provider 1918, and/or request module 1920 of FIG. 19; or any portion or combination thereof, for example, though the scope of the embodiments is not limited in this respect.

CAPTCHA generator 108, counter module 502, character generator 504, distortion determination module 506, character distorter 508, attribution module 510, comparison module 512, CAPTCHA provider 514, restriction module 516, content request receipt module 1102, character generator 1104, surface generator 1106, light orientation selector 1108, character orientation selector 1110, projector module 1112, CAPTCHA provider 1114, rotation request determination module 1116, scene rotator 1118, proposed solution determination module 1120, correctness determination module 1122, access provider 1124, threshold module 1126, counter module 1128, comparison module 1130, object selector 1302, object combiner 1304, object selector 1902, counter module 1904, modification determination module 1906, characteristic modifier 1908, comparison module 1910, object combiner 1912, light orientation selector 1914, shadow generator 1916, CAPTCHA provider 1918, and request module 1920 may be implemented in hardware, software, firmware, or any combination thereof.

For example, CAPTCHA generator 108, counter module 502, character generator 504, distortion determination module 506, character distorter 508, attribution module 510, comparison module 512, CAPTCHA provider 514, restriction module 516, content request receipt module 1102, character generator 1104, surface generator 1106, light orientation selector 1108, character orientation selector 1110, projector module 1112, CAPTCHA provider 1114, rotation request determination module 1116, scene rotator 1118, proposed solution determination module 1120, correctness determination module 1122, access provider 1124, threshold module 1126, counter module 1128, comparison module 1130, object selector 1302, object combiner 1304, object selector 1902, counter module 1904, modification determination module 1906, characteristic modifier 1908, comparison module 1910, object combiner 1912, light orientation selector 1914, shadow generator 1916, CAPTCHA provider 1918, and/or request module 1920 may be implemented as computer program code configured to be executed in one or more processors.

In another example, CAPTCHA generator 108, counter module 502, character generator 504, distortion determination module 506, character distorter 508, attribution module 510, comparison module 512, CAPTCHA provider 514, restriction module 516, content request receipt module 1102, character generator 1104, surface generator 1106, light orientation selector 1108, character orientation selector 1110, projector module 1112, CAPTCHA provider 1114, rotation request determination module 1116, scene rotator 1118, proposed solution determination module 1120, correctness determination module 1122, access provider 1124, threshold module 1126, counter module 1128, comparison module 1130, object selector 1302, object combiner 1304, object selector 1902, counter module 1904, modification determination module 1906, characteristic modifier 1908, comparison module 1910, object combiner 1912, light orientation selector 1914, shadow generator 1916, CAPTCHA provider 1918, and/or request module 1920 may be implemented as hardware logic/electrical circuitry.

In accordance with an example embodiment, a CAPTCHA generator (e.g., CAPTCHA generator 108) generates a CAPTCHA when a user attempts to access content (e.g., when a Web page is rendered). In accordance with another example embodiment, a CAPTCHA generator generates a CAPTCHA before a user attempts to access content. For instance, the CAPTCHA may be generated when usage of a Web site is relatively low. In accordance with this example embodiment, the CAPTCHA generator may store the CAPTCHA in a store (e.g., database) and cross-reference the CAPTCHA with an indicator that specifies a solution for the CAPTCHA. For instance, the indicator may specify a string of characters, a designated virtual 3D object, etc. In further accordance with this example embodiment, the CAPTCHA generator may retrieve the CAPTCHA to be provided to a user when the user attempts to access the content (e.g., when usage of the Web site is relatively high).

### IV. Example Computer Implementation

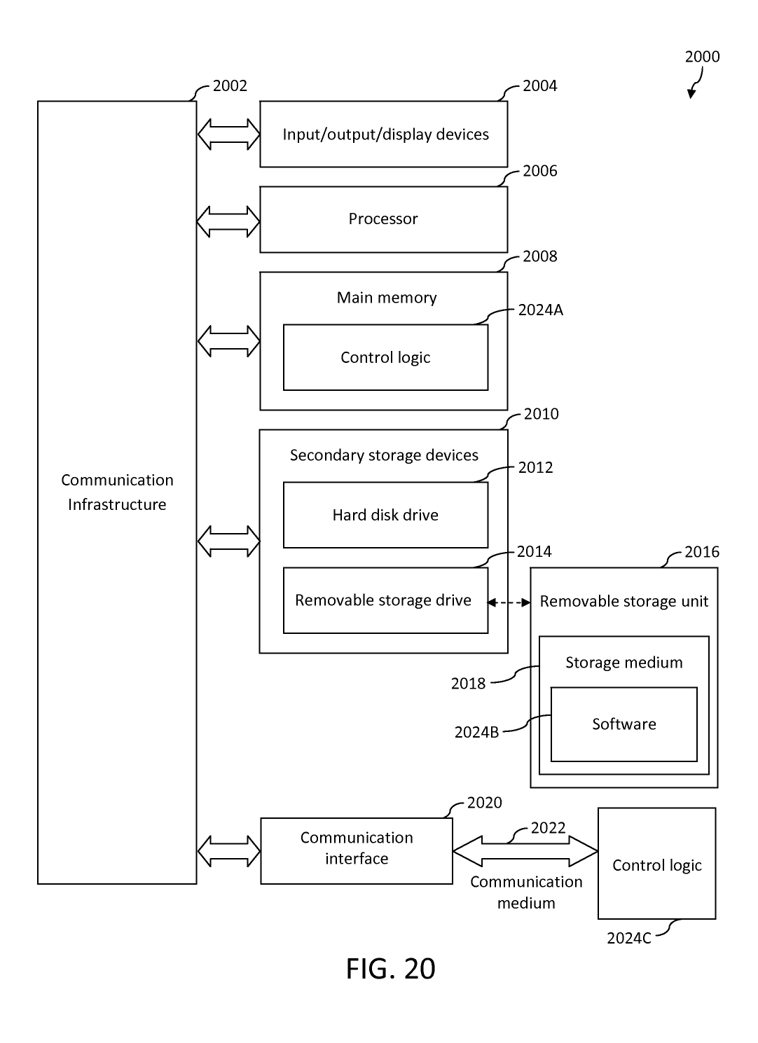

The embodiments described herein, including systems, methods/processes, and/or apparatuses, may be implemented using well known servers/computers, such as computer 2000 shown in FIG. 20. For example, elements of example computer system 100, including any of the user systems 102A-102M depicted in FIG. 1 and any of the servers 106A-106N depicted in FIGS. 1, 5, 11, and 19 and elements thereof, and each of the steps of flowcharts 200, 300, 400, 900, 1000, 1200, and 1800 depicted in respective FIGS. 2, 3, 4, 9A-9B, 10, 12, and 18 can each be implemented using one or more computers 2000.

Computer 2000 can be any commercially available and well known computer capable of performing the functions described herein, such as computers available from International Business Machines, Apple, Sun, HP, Dell, Cray, etc. Computer 2000 may be any type of computer, including a desktop computer, a server, etc.

As shown in FIG. 20, computer 2000 includes one or more processors (e.g., central processing units (CPUs)), such as processor 2006. Processor 2006 may include CAPTCHA generator 108 of FIG. 1; counter module 502, character generator 504, distortion determination module 506, character distorter 508, attribution module 510, comparison module 512, CAPTCHA provider 514, and/or restriction module 516 of FIG. 5; content request receipt module 1102, character generator 1104, surface generator 1106, light orientation selector 1108, character orientation selector 1110, projector module 1112, CAPTCHA provider 1114, rotation request determination module 1116, scene rotator 1118, proposed solution determination module 1120, correctness determination module 1122, access provider 1124, threshold module 1126, counter module 1128, and/or comparison module 1130 of FIG. 11; object selector 1302 and/or object combiner 1304 of FIG. 13; object selector 1902, counter module 1904, modification determination module 1906, characteristic modifier 1908, comparison module 1910, object combiner 1912, light orientation selector 1914, shadow generator 1916, CAPTCHA provider 1918, and/or request module 1920 of FIG. 19; or any portion or combination thereof, for example, though the scope of the embodiments is not limited in this respect. Processor 2006 is connected to a communication infrastructure 2002, such as a communication bus. In some embodiments, processor 2006 can simultaneously operate multiple computing threads.

Computer 2000 also includes a primary or main memory 2008, such as a random access memory (RAM). Main memory has stored therein control logic 2024A (computer software), and data.

Computer 2000 also includes one or more secondary storage devices 2010. Secondary storage devices 2010 include, for example, a hard disk drive 2012 and/or a removable storage device or drive 2014, as well as other types of storage devices, such as memory cards and memory sticks. For instance, computer 2000 may include an industry standard interface, such as a universal serial bus (USB) interface for interfacing with devices such as a memory stick. Removable storage drive 2014 represents a floppy disk drive, a magnetic tape drive, a compact disk drive, an optical storage device, tape backup, etc.

Removable storage drive 2014 interacts with a removable storage unit 2016. Removable storage unit 2016 includes a computer useable or readable storage medium 2018 having stored therein computer software 2024B (control logic) and/or data. Removable storage unit 2016 represents a floppy disk, magnetic tape, compact disc (CD), digital versatile disc (DVD), Blue-ray disc, optical storage disk, memory stick, memory card, or any other computer data storage device. Removable storage drive 2014 reads from and/or writes to removable storage unit 2016 in a well known manner.

Computer 2000 also includes input/output/display devices 2004, such as monitors, keyboards, pointing devices, etc.

Computer 2000 further includes a communication or network interface 2020. Communication interface 2020 enables computer 2000 to communicate with remote devices. For example, communication interface 2020 allows computer 2000 to communicate over communication networks or mediums 2022 (representing a form of a computer useable or readable medium), such as local area networks (LANs), wide area networks (WANs), the Internet, etc. Network interface 2020 may interface with remote sites or networks via wired or wireless connections. Examples of communication interface 2022 include but are not limited to a modem, a network interface card (e.g., an Ethernet card), a communication port, a Personal Computer Memory Card International Association (PCMCIA) card, etc.

Control logic 2024C may be transmitted to and from computer 2000 via the communication medium 2022.

Any apparatus or manufacture comprising a computer useable or readable medium having control logic (software) stored therein is referred to herein as a computer program product or program storage device. This includes, but is not limited to, computer 2000, main memory 2008, secondary storage devices 2010, and removable storage unit 2016. Such computer program products, having control logic stored therein that, when executed by one or more data processing devices, cause such data processing devices to operate as described herein, represent embodiments of the invention.

For example, each of the elements of example servers 106A-106N, including CAPTCHA generator 108 depicted in FIG. 1; counter module 502, character generator 504, distortion determination module 506, character distorter 508, attribution module 510, comparison module 512, CAPTCHA provider 514, and restriction module 516, each depicted in FIG. 5; content request receipt module 1102, character generator 1104, surface generator 1106, light orientation selector 1108, character orientation selector 1110, projector module 1112, CAPTCHA provider 1114, rotation request determination module 1116, scene rotator 1118, proposed solution determination module 1120, correctness determination module 1122, access provider 1124, threshold module 1126, counter module 1128, and comparison module 1130, each depicted in FIG. 11; object selector 1302 and object combiner 1304, each depicted in FIG. 13; object selector 1902, counter module 1904, modification determination module 1906, characteristic modifier 1908, comparison module 1910, object combiner 1912, light orientation selector 1914, shadow generator 1916, CAPTCHA provider 1918, and request module 1920, each depicted in FIG. 19; and each of the steps of flowcharts 200, 300, 400, 900, 1000, 1200, and 1800 depicted in respective FIGS. 2, 3, 4, 9A-9B, 10, 12, and 18 can be implemented as control logic that may be stored on a computer useable medium or computer readable medium, which can be executed by one or more processors to operate as described herein.

### V. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of generating a CAPTCHA, comprising:
generating a first character that has a first outer boundary;
generating a second character that has a second outer boundary, the second outer boundary intersecting the first outer boundary to provide an overlapping region with respect to the first and second characters;
determining that the overlapping region is to be attributable to a specified character, the specified character being the first character or the second character; and
providing a CAPTCHA to a user, the CAPTCHA including the first character and the second character arranged such that the overlapping region is attributable to the specified character.

2. The method of claim 1, further comprising:
generating a third character that has a third outer boundary, the third outer boundary intersecting the second outer boundary to provide a second overlapping region with respect to the second and third characters;
determining that the second overlapping region is to be attributable to a second specified character, the second specified character being the second character or the third character; and
wherein providing the CAPTCHA comprises:
providing a CAPTCHA that includes the first character, the second character, and the third character arranged such that the first and second overlapping regions are attributable to the respective first and second specified characters.

3. The method of claim 1, further comprising:
specifying a maximum proportion of an area of a non-specified character that the specified character is capable of overlapping;
wherein the non-specified character is the first character or the second character that is not the specified character; and
wherein providing the CAPTCHA comprises:
providing the CAPTCHA to the user, the CAPTCHA including the first character and the second character arranged such that the overlapping region is attributable to the specified character and such that the specified character overlaps a designated proportion of the area of the non-specified character, the designated proportion being less than or equal to the maximum proportion.

4. The method of claim 1, further comprising:
determining that a third character is not to be generated next to the first character;
wherein generating the second character comprises:
generating the second character in response to determining that the third character is not to be generated next to the first character.

5. The method of claim 1, further comprising:
distorting at least one of the first or second characters;
wherein providing the CAPTCHA comprises:
providing the CAPTCHA in response to distorting the at least one of the first or second characters.

6. The method of claim 5, wherein distorting the at least one of the first or second characters comprises:
rotating at least one of the first or second characters.

7. The method of claim 5, wherein distorting the at least one of the first or second characters comprises:
shearing at least one of the first or second characters.

8. The method of claim 5, wherein distorting the at least one of the first or second characters comprises:
curving at least one of the first or second characters.

9. The method of claim 5, wherein distorting the at least one of the first or second characters comprises:
blurring at least one of the first or second characters.

10. The method of claim 5, wherein distorting the at least one of the first or second characters comprises:
changing an angle between lines of at least one of the first or second characters.

11. A method of generating a CAPTCHA, comprising:
generating a string of characters;
generating a virtual three-dimensional surface;
projecting the string of characters on the virtual three-dimensional surface to provide a virtual three-dimensional scene that includes the virtual three-dimensional surface having a projection of the string of characters thereon; and
providing a CAPTCHA that includes the virtual three-dimensional scene to a user.

12. The method of claim 11, wherein generating the string of characters comprises:
randomly generating the string of characters.

13. The method of claim 11, wherein generating the virtual three-dimensional surface comprises:
randomly generating the virtual three-dimensional surface.

14. The method of claim 11, wherein generating the virtual three-dimensional surface comprises:
randomly selecting a plurality of virtual three-dimensional objects; and
randomly combining the plurality of virtual three-dimensional objects to generate the virtual three-dimensional surface.

15. The method of claim 11, further comprising:
receiving a request from the user to rotate the virtual three-dimensional scene about an axis; and
rotating the virtual three-dimensional scene about the axis in response to receiving the request.

16. The method of claim 15, further comprising:
establishing a threshold number of times that the user is allowed to rotate the virtual three-dimensional scene; and
not rotating the virtual three-dimensional scene when a number of times that the virtual three-dimensional scene is rotated is equal to or greater than the threshold number.

17. The method of claim 11, further comprising:
selecting an orientation of a virtual light source that is used to project the string of characters on the virtual three-dimensional surface from a plurality of orientations.

18. The method of claim 11, further comprising:
determining an orientation of the string of characters between the three-dimensional surface and a virtual light source that is used to project the string of characters on the virtual three-dimensional surface.

19. A method of generating a CAPTCHA, comprising:
randomly selecting a plurality of virtual three-dimensional objects;
randomly combining the plurality of virtual three-dimensional objects to generate a virtual three-dimensional structure;
providing a CAPTCHA that includes the virtual three-dimensional structure to a user; and
requesting that the user identify a designated virtual three-dimensional object of the plurality of virtual three-dimensional objects in the virtual three-dimensional structure.

20. The method of claim 19, wherein randomly combining the plurality of virtual three-dimensional objects comprises:
obscuring at least a portion of a first virtual three-dimensional object of the plurality of virtual three-dimensional objects by a second virtual three-dimensional object of the plurality of virtual three-dimensional objects.

21. The method of claim 19, further comprising:
modifying at least one characteristic of a first virtual three-dimensional object of the plurality of virtual three-dimensional objects in response to randomly selecting the plurality of virtual three-dimensional objects;
wherein randomly combining the plurality of virtual three-dimensional objects comprises:
randomly combining the plurality of virtual three-dimensional objects in response to modifying the at least one characteristic of the first virtual three-dimensional object.

22. The method of claim 19, wherein providing the CAPTCHA to the user comprises:
providing the CAPTCHA that further includes a shadow of the designated virtual three-dimensional object to the user.

23. The method of claim 22, further comprising:
selecting an orientation of a virtual light source that is used to generate the shadow of the designated virtual three-dimensional object from a plurality of orientations.
